(19) United States
(12) Patent Application Publication
(10) Pub. No.: US 2002/0150658 A1
(43) Pub. Date: Oct. 17, 2002

(54) Food package containing food products in separate compartments separated by a burst seal and method of making

(76) Inventors: Clint Morrissette, St. Michael, MN (US); Malathy Nair, Plymouth, MN (US); Karen Graham, Plymouth, MN (US); Jonathan Paul, Mound, MN (US)

Correspondence Address: John A. O'Toole, Esq., P. O. Box 1113, Minneapolis, MN, 55440, US

(21) Appl. No.: 09/835,664

(22) Filed: Apr. 16, 2001

(51) Int. Cl. A23B 4/00

(52) U.S. Cl. 426/120

(57) ABSTRACT

Consumer packaged food articles fabricated from a flexible film comprise at least two compartments or chambers containing different food components isolated from each other by an intermediate partition or seal that prevents mixing of the contents of the compartments or chambers prior to purchase by the consumer. The package is constructed to permit mixing of the two components in the package by the consumer prior to consumption of the mixed product. The contents of the two compartments can be interactive chemically and/or physically to provide enhanced interest in the product to be consumed. The package can comprise a tube with at least two compartments that are separated by a seal that is more readily broken than the seal forming the periphery of the package, i.e., a “burst” seal. After purchase by the consumer, the consumer applies sufficient pressure to the tube to burst the seal separating the compartments. Once the seal is broken, the two components in the separate compartments or chambers can be cause to interact by the consumer. This interaction can cause a color change by mixing two differently colored components to form a third color. Other interactions include the formation and/or release of a gas, such as carbon dioxide or the like. Preferred use if for refrigerated yogurt products for children.

### FIELD OF THE INVENTION

The present invention relates to packaged food products and to methods for the preparation and uses thereof. More particularly, the present invention is directed to a packaged food product that provides excellent nutritional value and at the same time is fun to eat. A particular aspect of the invention relates to dairy products such as a yogurt-containing product.

### BACKGROUND

Yogurt is a popular and nutritious food product. At retail, yogurt is now available in a wide assortment of varieties of texture, fat content and flavor among other attributes. Other than aseptically packaged yogurt, yogurt is traditionally distributed and consumed with a live culture that requires refrigerated storage and distribution, usually at a temperature of 34 to 40° F. (1° C. to 4.5° C.). Most yogurt is packaged and sold in a cup or pot. However, other package forms of yogurt are currently available and are enjoying increased popularity. The currently marketed yogurt containing product, Go-Gurt® brand, is an example. The packaged yogurt food good marketed under the Go-Gurt® or Exprèsse™ marks comprises a tube like structure or pouch defining an inner cavity disposed within which is a quantity of yogurt, e.g., about 50-75 grams of yogurt. The tube like structure is made of flexible plastic laminated film and is sealed at both ends. This product is stored in a refrigerated state and is usually eaten by opening one end of the tube and squeezing the product out of the tube directly into the consumer's mouth. This product has enjoyed considerable success in the market. It provides an excellent snack food, especially for active people, including children and young adults, as it is convenient to eat, does not require any utensils, is easy to store and carry and is nutritious. After consuming the yogurt, the empty tube like structure or pouch can simply be appropriately discarded.

The present invention provides an improvement in such popular yogurt products in tube form by adding at least a second tube or pouch section containing a second food material.

### SUMMARY OF THE INVENTION

One packaged food article aspect of the invention is to provide a food product in a package having at least two compartments or chambers isolated from each other by a partition or seal which prevents mixing of the contents of the compartments or chambers prior to purchase by the consumer. However, the package is constructed to permit mixing of the two components in the package by the consumer prior to consumption of the mixed product. The contents of the two compartments can be interactive chemically and/or physically to provide enhanced interest in the product to be consumed. The package can comprise a tube with at least two compartments that are separated by a seal which is more readily broken than the seal forming the periphery of the package, i.e., a “burst” seal. After purchase by the consumer, the consumer applies sufficient pressure to the tube to burst the seal separating the compartments. Once the seal is broken, the two components in the separate compartments or chambers can be cause to interact by the consumer. This interaction can cause a color change by mixing two differently colored components to form a third color. Other interactions include the formation and/or release of a gas, such as carbon dioxide or the like.

In its method aspect of one and the same invention, the present invention resides in methods of forming the packaging containing at least two separate compartments or chambers for at least two components separated by an appropriate burst seal and the method of filling the packaging form a further aspect of the invention.

### BRIEF DESCRIPTION OF THE DRAWINGS

FIG. 1 is a schematic representation of the packaging with two chambers.

FIG. 2 is a schematic representation of the packaging with three chambers.

All figures are drawn for ease of explanation of the basic teachings of the present invention only; the extensions of the figures with respect to number, position, relationship and dimensions of the parts to form the preferred embodiments will be explained or will be within the skill of the art after the following description has been read and understood. Further, the exact dimensions and dimensional proportions to conform to specific force, weight, strength, and similar requirements will likewise be within the skill of the art after the following description has been read and understood.

### DETAILED DESCRIPTION OF THE INVENTION

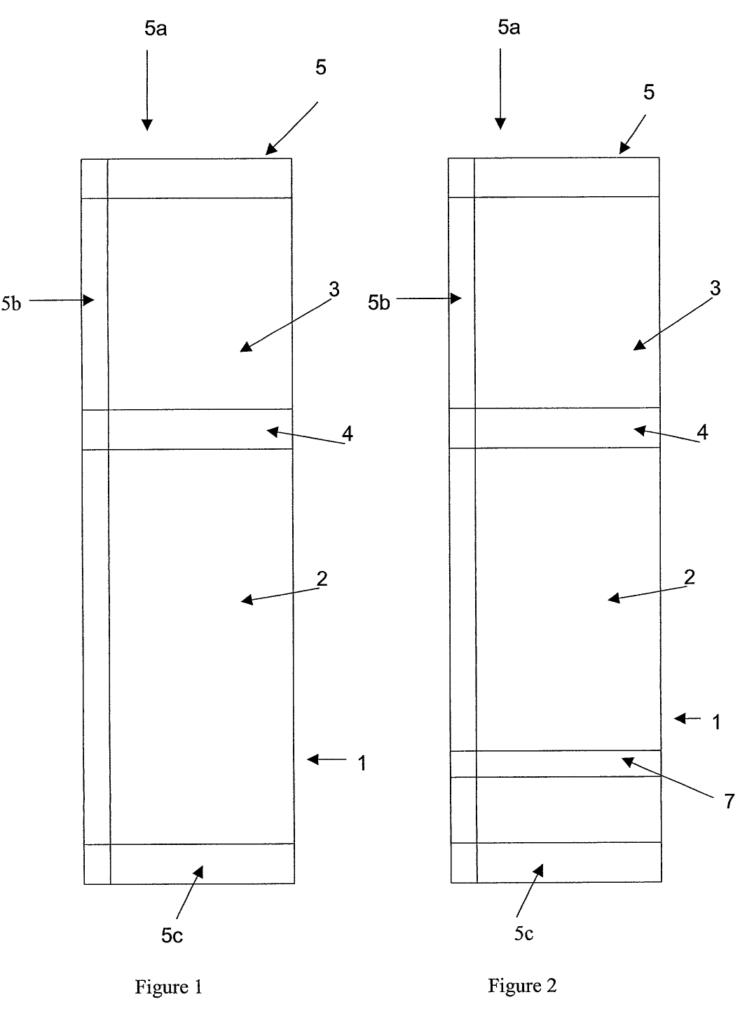

In one aspect of the invention, the package makes use of a horizontal burst seal to make a fun, interactive yogurt containing package in the form of a tube with multiple chambers or compartments, each separated by a seal. This aspect of the invention is shown in FIG. 1. Flexible tube 1 is divided into compartments 2 and 3 that are separated by burst seal 4. Compartments 2 and 3 can be of any size depending on the results to be achieved, but are shown respectively as having ⅔ and ⅓ of the volume of the contents of the tube. Compartment 2 contains the food product that can be yogurt. Compartment 3, is filled with a second component which is separated from the food product by burst seal 4 until the two are mixed by the consumer. The relative size and number of compartments can be selected depending on the end result desired.

While the present invention finds particular suitability for use in connection with cultured dairy products such as yogurt, the skilled artisan will appreciate that the present invention finds suitability for use in connection with a wide variety of food products in which separation of one component from another until immediately prior to consumption is desired. For example, the products can be of different colors. The product components can be of different moisture contents. For example, the first compartment can contain a relatively wet component such as yogurt and the second compartment contain a dry particulate material such as the “poprocks” type confectionery described in detail below. In another variation, the dry component can be a dry ready-to-eat cereal and the wet portion can comprise fluid milk. In still another variations the wet material component can comprise a fluid batter such as a farinaceous batter for chemically leavened baked goods (e.g., layer cakes, muffins, quick breads, brownies or other dessert baked goods) or pan goods (e.g., pancakes) such as including an acidulant or at least one baking acid and the dry component can be a chemical leavening system or component thereof such as baking powder or soda (sodium bicarbonate). Packaging in the present articles comprising a burst seal will allow for admixture immediately prior to usage thus avoiding the undesirable loss of leavening power over time due to interaction of the leavening ingredient or system with the batter. In still another variation, the wet or semi-solid food component can comprise a fruit sauce or puree. In still other variations, each food component can be dry but of differing water activities or moisture content. For example, one food component can be a dry ready-to Eat cereal with a water activity of below about 0.3 (A_{W} less than 0.3), e.g., whole wheat flakes, while the second food ingredient has a higher water activity, e.g., raisins having a A_{W}≈0.4. By separating the two dry components, moisture migration is minimized thereby reducing the staling or loss of crispness in the wheat flakes due to moisture gain and the hardening of the raisins due to moisture loss. In still other embodiments, the wet ingredient can be a fluid milk or thickened milk product such as a pudding.

Depending in part upon the selection of the food components, the present packaged food articles can be distributed and stored under different conditions. For example, those embodiments containing yogurt having live active cultures or fresh milk can be distributed under refrigerated conditions. If desired, the yogurt component of the products can be formulated component to allow freezing by the consumer after purchase to provide a frozen yogurt treat. Those product having two dry food components can be distributed at room temperature. Products having aseptically processed milk can also be distributed at room temperatures even though consumers can refrigerate prior to consumption, if desired.

The peripheral edge of the packaged is sealed with seal 5 to protect the contents of the package prior to use. It is important to the use of the product that the burst seal 4, or at least a portion thereof, is weaker than the edge seal 5 so that by applying pressure to the package, the seal 4 burst and allows the two components to be mixed without bursting the peripheral seals. This is necessary to maintain the overall integrity of the package prior to and during mixing of the components by the consumer. The two components are mixed by the consumer to the extent desired by applying sufficient pressure to the contents of the package to burst at least a portion of the burst seal separating the compartments and forcing the contents of one or the other compartment into the other compartment and mixing the two components. Adequate pressure can be applied by squeezing the package to cause the burst seal to break and the components to mix after which the package is opened and the product is removed from the package and consumed.

It is important to the interactive aspect of the invention for the consumer to control the direction of movement of one component from one chamber or compartment into a second or third compartment. This allows the consumer to control the amount of one component mixed with the other in the product to be consumed. This can vary from complete mixing to no mixing and provides the consumer with the option of consuming the product without mixing. That is, each component can be individually consumed by opening the compartments from one of the seals without causing the burst seal to break.

However, it will be advantageous to mix the products rather than to consume them separately. The more fluid product will generally be forced into the chamber containing the less fluid product following general principles of fluid dynamics. Specifically, the yogurt product will be forced into the chamber containing a second component.

The second component can, for example, enhance the interest in the food product. The second component to be mixed with the food product can be, for example, a noise producing ingredient such as a gasified confectionery or candy, commonly known as poprocks.

A gasified candy is described in U.S. Pat. No. 4,2756,083. As described therein, gasified candy is a hard candy containing a gas, such as carbon dioxide, as disclosed in U.S. Pat. Nos. 3,012,893 of Kremzner and Mitchell; 3,985,909 and 3,985,910 of Kirkpatrick and 4,001,457 of Hegadom which are incorporated herein by reference. Such a candy is made by a process which comprises melting crystalline sugar, contacting such sugar with gas at a pressure of 50 to 1,000 psig for a time sufficient to permit incorporation in the sugar of 0.5 to 15 ml. of gas per gram of sugar, maintaining the temperature of the sugar during the adsorption of the gas above the solidification temperature of the melted sugar, and cooling the sugar under pressure to produce a solid amorphous sugar containing the gas. Upon the release of the pressure the solid gasified candy fractures into granules of assorted sizes.

The resultant gasified product contains 1% to 4% water and most typically 2% to 3% water by weight of the total composition. (All percentage figures herein are in terms of weight percent, unless expressly stated otherwise.) Lower levels of moisture are not practicably obtainable because the additional heat necessary to drive off the water causes the candy melt to caramelize or burn, resulting in an off-flavor, undesirable product. Higher moisture levels result in a soft, sticky matrix that rapidly liberates the entrapped gas and is thus not storage stable.

The gasified candy when placed in the mouth produces an entertaining but short-lived popping or sizzling sensation. As the candy is wetted in the mouth the candy melts and the gas escapes. The gasified candy has to be stored separately from the yogurt since the moisture in the yogurt would cause release of the entrapped gas and destroy the desired effect of the product. In accordance with the present invention, the gasified candy is stored in one of the compartments, for example, compartment 3, and the yogurt in the other compartment, for example, compartment 2 of the plastic tube.

In a preferred aspect as shown in FIG. 1, the tube 1 is defined by an upper transverse seal 5(a) a lower transverse seal 5(c), a longitudinally extending side seal 5(b), and a longitudinally extending curvilinear side. The tube length is about 8 to 10 inches and about 2 to 3 inches in diameter. The tube is constructed from a sealable plastic film material of a laminate structure designed to provide moisture, oxygen, and light impermeability. Each seal is made by conventional means such as heat sealing jaws. The upper transverse seal has a notch and cut feature that facilitates opening of the tube by the consumer by tearing the film at about the upper transverse seal.

The laminated plastic filn material can be any of a number of well known and commercially available films. U.S. Pat. No. 5,287,961 describes heat sealable films of the type which can be used in the present invention. As described therein, the thermoplastic material used to form the packages is provided in sheet or film form and can be any of the films used for this type of packaging. For example, the thermoplastic film can be a polyolefin film made from olefin polymers, such as ethylene, propylene, butylene, and the like. More often, however, the film will be a commercially available multilayer film having a sealant layer, a barrier layer and one or more strength layers. The particular multilayered film used will in part depend upon the end use of the package. A preferred material for the strength layers is a polyamide such as biax nylon from 0.5 mil to about 1.5 mils in thickness. Where barrier properties are desired a layer of polyvinylidene chloride (PVDC) or copolymer of ethylene vinyl alcohol (EVOH) can be used. The sealant layer can be any other of the well known Polymers suitable for that purpose such as ethylene vinylacetate, low density polyethylene, linear low density polyethylene, or an ionomer such as Surlyn.RTM. (DuPont).

The films can be coextruded or laminated and can be adhered together with a coextruded tie layer such as ethylene vinylacetate, an ionomer, anhydride grafted ethylene vinylacetate, low density polyethylene or linear low density polyethylene. The typical film to film bond from lamination is made by adhering the films together with a thin layer of polyurethane coating on an adhesive laminator. This lamination can also be accomplished by extrusion lamination or extrusion coating with an adhesive coextrusion tie layer type resin at the bond interface. The multi-layered films are typically from 0.75 mils to 5.0 mils thick, preferably about 1.5 to about 3.0 mils thick.

Films used to package foods where protection from oxygen and light are important are especially preferred since yogurt is sensitive to deterioration by light, especially, UV and oxygen. Such films include a polyethylene resin film such as a metalocene linear low density co-extrusion with an ethylene vinyl alcohol skin. Metalocene is a particular type of polyethylene resin known for excellent hot tack characteristics. The hot tack characteristics include the ability to seal at a wide range of heat seal profiles, durations of time and temperatures variances. It is also known to be a very good caulking material in case there is contamination in the seal area. It is very inert and it does not impart off flavor or off odors to products it comes in contact with and in turn it does not take on characteristics from the product itself.

The ethylene vinyl alcohol skin imparts to the film protective properties against the effect of oxygen and light. It also acts as a scavenger for any kind of residual contaminants that can be introduced into the packaging structure as it is made. Cleaning components, oils, esters, hot products, residual products that are left over after the plastic is melted and extruded through an extrusion dye. The ethylene vinyl alcohol skin, in addition to being an oxygen barrier, will tend to scavenge off those residual components that are left over in the packaging structure itself.

The light barrier is an important aspect of the invention if the product is to be sold without further packaging such as in cartons which prevent exposure to light which can be harmful to yogurt. Dairy products sold in opaque cartons or packages are protected from light by the opaque packaging. However, the visual effect of the product is important and adds interest to the product by the consumer. Thus, in preferred embodiments at least a portion of the plastic film is clear so that the degree of or effect of intermixing is observable. In certain variations, for example, a portion of a protective outer layer from a laminate film is cut away to reveal underlying clear layers of the plastic film. The contents of the product in each compartment can be different and form a third color when mixed. This can be variable depending upon the colors of the components to be mixed and the degree of mixing. The latter variable is controlled by the consumer. In any case, it is preferable that the mixing is visible to the consumer.

This can be accomplished in a number of different ways. For example, beer is a very light sensitive product but yet beer is sold in clear containers. The reason that beer can be sold in clear containers is that there are silica coatings that detract certain visible ranges of light. Those silica coatings can be put down at certain quantities, certain pounds per ream across the surface of packaging materials and can accomplish light barrier effect at a minimal cost. Oxygen scavengers can also be added to the film structure in known ways to provide protection from any deterioration by oxygen.

The package is fabricated and filled in a vertical package machine. The film is first formed into a tube by sealing the longitudinal edge and bottom edge in a conventional manner on conventional automated equipment. This results in a tube having a bottom seal and one longitudinal edge or side sealed and having a curvilinear side. In a less preferred embodiment, a more conventional container pouch design can be employed in which the curvilinear side is substituted with a second side seal. Such conventional pouches are used for example for catsup More specifically, the invention contemplates adding at least a first transverse burst seal to divide the single compartment into at least two compartments as shown in FIG. 1, namely, a major compartment or cavity and at least a first minor compartment or cavity. However, a prescribed amount of an ingredient, such as yogurt, is first added to the tube before the traverse burst seal is formed, generally by heated sealing jaws as is conventional in the art. After the ingredient is added, the sealing jaws form the first traverse burst seal. The transverse burst seal is characterized by a seal failure pressure substantially less than the seal failure pressure that will characterize the upper traverse seal closing the tube and the lower transverse seal and the longitudinally extending side seal.

While in the preferred embodiment the transverse burst seam is linear and perpendicular to the edge seal, in other variations the seal can be of different shapes such as curvilinear, a straight line but at an lesser or greater angle than perpendicular to the edge seal, a zig-zag pattern or other shapes such as for aesthetic purposes. Also, while edge seal 5b is depicted as being longer than upper transverse seal or lower transverse seal 5c, the skilled artisan will appreciate that other variations of dimension are possible. Also, while the package described in the preferred embodiment is a simple tube, other shapes of the package can be employed without departing from the invention, square pouches with one or two edge seals, oval or circular pouches or even fanciful shapes such as the outline of animals, or article such as cars or airplanes.

The transverse burst seal is defined by a seal failure pressure ranging from about 30 to 45 psig (˜310 kPa. to about 415 kPa.) as can be determined by the sealing jaws used to form the seal. In one aspect of the invention, the failure pressure of the burst seal can vary in different parts of the seal itself so that one portion of the seal breaks first which allows movement of one of the components through a more limited area or orifice to enhance a visual effect in the mixing of different colored components, such as white yogurt and a red flavoring to give a swirl effect.

The upper transverse seal, the lower transverse seal, and the side seal are each characterized by a seal failure pressure of greater than 200 psig.

After the first burst seal is formed, the second food component, such as gasified candy, is filled into the tube in the desired amount and the final traverse or closure seal is formed. However, the pressure or heat applied by the sealing jaws is varied to provide the required strength to the closure seal. The same sealing jaws that create the upper and lower seals can be used to fabricate the burst seal by minor changes to the heating temperature during the sealing step, and/or by adjustment of the sealing step duration and pressure. This technique can also be used to provide a variance in the failure pressure within the burst seal to provide additional effects as previously discussed.

The width of the seals range from about 0.25 to 0.75 inches as determined by the size of the sealing jaws which form the seal. These dimensions can vary as would be appreciated by one skilled in the art. The width of the seals can affect the strength of the seal. The width of the traverse seal can be narrower than the width of the peripheral seal. The minor cavity formed by the traverse seal can range in size from about 5 to 15 cc and in length from about 2 to 3 (5 to ˜8 cm) inches. This size compartment will accommodate about 0.5 to 5 grams of additive. The minor cavity can contain a dry ingredient such as pop rocks, colored sugar, or mixtures thereof. In the preferred embodiment, the minor cavity is disposed towards the upper transverse seal.

The upper transverse seal additionally comprises a notch feature to facilitate opening for consumption.

In an alternate embodiment, the tube includes a second transverse burst seal to define a second minor compartment. In this embodiment, the first minor compartment is disposed proximate the upper transverse seal while the second minor compartment is made proximate the lower transverse seal. The first and second minor compartments are about an inch to about 2.5 inches in length and can accommodate about 0.5 to about 3 grams of product, such as a solid confectionary that releases CO₂ gas upon consumption or contact with moisture commonly referred to as “poprocks”.

The major compartment, preferably can contain from about 30 to 70 grams of yogurt depending on the size of the compartment which 4 to about 7 inches (10-35 cm.).

The strength of the burst seal feature is such that upon squeezing of the food materials such as yogurt disposed within the major compartment causes the burst seal to rupture. Such rupture then allows for the intermixture of the dry material such as pop rocks with the wet food material, such as yogurt. The yogurt preferably has a viscosity of from 11,000 to 43,000 cps.

Upon such admixture, the pop rocks began to pop in the known manner leading to the novel and pleasing popping sound feature. The poprocks preferably have a particle size range of US Standard sieve of 4 mesh to 35 mesh, and a density of about 0.8 g/cc. Having a second minor compartment proximate the lower transverse seal allows for a delayed intermixture of the pop rocks materials disposed within the second minor compartment. This allows for an extension of the pleasing novel popping phenomenon.

By appropriately sizing the poprocks and by control of the quantity of the pop rocks, the popping phenomenon can be extended up too as long as five minutes.

Such extension of the popping phenomenon can allow for the phenomenon to pleasing continue to occur even during consumption and thus within the mouth.

And other variations, other in particulate material can be used in substitution for the pop rocks. For example, the dry particulate material can be dried or infused fruit pieces, granola, dried cereal pieces, aerated confections (e.g., dried marshmallow pieces, ground candy or candy bar pieces) and mixtures thereof.

In another variation, the solid dry material can be substituted with a fluid or liquid material, e.g., a second yogurt portion of a second color and/or flavor or a second food material such as fruit puree. FIG. 2 schematically represents this additional feature and shows the package of FIG. 1 with an additional compartment 6 for the third component formed by an additional burst seal 7. Additional chambers or compartments also can be included as would be obvious to one of ordinary skill in the art.

The consumer prepares the components for consumption by hand manipulation of the compartment containing the more liquid component as this facilitates breakage of the burst seal by pressure transfer through the more fluid material. If two liquids are present, either side can be manipulated. Preferably, such manipulation is in the form of squeezing, twisting or pressing on the compartment to create sufficient pressure to burst, sever, separate, rupture, or open the burst seal. Opening of the burst seal allows the components contained in the separated compartments to be placed in communication with each other for intermixing. The intermixing can be performed by manually squeezing or kneading the compartments from side to side until the compartments are mixed to the extent desired by the consumer to obtain the desired results. In multi compartment packages that contain additional food pieces, for example, fruit pieces, candy, or nuts, it can be desirable to mix the components in the other compartments before the addition of the food pieces.

What is claimed:

1. A food product in a flexible plastic film package having at least two compartments isolated from each other by a partition which prevents mixing of food components contained in the compartments until adequate pressure is applied to the partition to burst the partition and allow mixing of the two components.

2. The food product of claim 1, wherein the partition comprise a burst seal.

3. The food product of claim 2, wherein the food component disposed within of one of the compartments is a wet food component.

4. The food product of claim 4 wherein the wet food component is a dairy component selected from the group consisting of milk, yogurt, cream, sour cream and kefir.

5. The food product of claim 1 wherein the flexible film package is in the form of a tube form from a laminate plastic film sealed on the peripheral edges, with the partition formed as a traverse seal of the laminated plastic film.

6. The food product of claim 5 wherein the peripheral edge seal has a bursting strength of at least 200 psig and the traverse seal has a bursting strength of 25 to 45 psig.

7. The food product of claim 6, wherein one compartment contains yogurt and the second compartment contains a gasified candy.

8. The food product of claim 6, wherein each compartment contains a yogurt product of different color.

9. The food product of claim 8 wherein the dry particulate is a gas containing candy product.

10. The food product of claim 2 wherein at least one food component is a dry particulate.

11. The food product of claim 1, wherein the package has three compartments form by two partitions.

12. The food product of claim 11 wherein each partition is formed by a burst seal.

13. The food product of claim 12 wherein the compartments are of different volumes.

14. The food product of 11 wherein at least one food component if yogurt.

15. The food product of claim 2 wherein the wet food component is a farinaceous batter.

16. The food product of claim 15 wherein the farinaceous batter is acidified to a pH of below 4.5 and comprises at least one baking acid.

17. The food product of claim 5 wherein at least a portion of the plastic film is clear.

18. The food product of claim 4 wherein the dairy component is milk.

19. The food product of claim 4 wherein the milk is refrigerated fluid milk.

20. A method fabricating and vertically filling the food product of claim 1, which comprises:
forming a laminated film into a tube with an open end by pressure and heat sealing a longitudinal edge and bottom edge of the laminated film to form a tube with a peripheral seal having a burst strength of at least 200 psig and an open end;
vertically filling the formed tube with a first food product through the open end to a predetermined level below the open end;
sealing the tube above the level of the first food product by heat and pressure to form a first compartment containing the first food product and a first traverse burst seal with a burst strength substantially less than the burst strength of the peripheral edge seal while simultaneously forming a second compartment for a second food product in the tube;
vertically filling the tube with a second food product; and
forming a closing seal to close the open end of said tube to form the food package product.

21. The method of claim 20, wherein the peripheral edge seal has a bursting strength of at least 200 psig (1485 kPa.) and the traverse seal has a bursting strength of 25 to 45 psig.

22. The method of claim 15, which further comprises forming a second traverse burst seal and a tube with at least three compartments.

23. The method 15, wherein the first food product is yogurt.

24. The method of claim 16, wherein the second food product is a gas containing candy product.
